(19) United States
(12) Patent Application Publication
(10) Pub. No.: US 2015/0327725 A1
(43) Pub. Date: Nov. 19, 2015

(54) Apparatus that will insure a healthy cooking of a wide range of produce using a minimum amount of oil, or in some cases no oil at all.

(71) Applicant: Spyridon A. Mpitzios, Ioannina (GR)

(72) Inventor: Spyridon A. Mpitzios, Ioannina (GR)

(21) Appl. No.: 14/583,802

(22) Filed: Dec. 29, 2014

(30) Foreign Application Priority Data
May 15, 2014 (GR) 20140100278

(51) Int. Cl. A47J 37/12

(52) U.S. Cl. CPC A47J 37/1219; A47J 37/1295

(57) ABSTRACT

The invention in question is an appliance for either cooking or frying all kinds of vegetables, potatoes as well as poultry and red meat.

The advantage of this construction is that the minimum oil or in some cases no oil at all can fry potatoes healthy, crunchy and flavorful.

The apparatus comprises a cooking chamber (3) having at its center the heat source (1), the specially made perforated drum (15) that rotates around the heat source (1) so that the pieces of the product are very close to the heat source (1). The perforated drum (15) is divided into four areas (20) or more depending on the design and size. The advantage of the perforated drum (15) is that when is rotated the pieces product collected from each sector in the center where it is the heat source (1) and have quick-fried without loss of power as the other devices.

### BRIEF SUMMARY OF THE INVENTION

Apparatus that will insure a healthy cooking of a wide range of produce using a minimum amount of oil, or in some cases no oil at all.

The invention in question is an appliance for either cooking or frying all kinds of vegetables, potatoes as well as poultry and red meat.

The advantage of this construction is that the minimum oil or in some cases no oil at all can fry potatoes healthy, crunchy and flavorful.

The apparatus comprises a cooking chamber (3) having at its center the heat source (1), the specially made perforated drum (15) that rotates around the heat source (1) so that the pieces of the product are very close to the heat source (1).

The perforated drum (15) is divided into four areas (20) or more depending on the design and size. The advantage of the perforated drum (15) is that when is rotated the pieces product collected from each sector in the center where it is the heat source (1) and have quick-fried without loss of power as the other devices.

### DETAILED DESCRIPTION OF THE INVENTION

Apparatus that will insure a healthy cooking of a wide range of produce using a minimum amount of oil, or in some cases no oil at all.

The invention in question is an appliance for either cooking or frying all kinds of vegetables, potatoes as well as poultry and red meat.

Since they are quite popular, French fries are consumed on a tremendously large scale. They are copiously served to garnish main courses in restaurants, offered on the counters of bars, and even sold on roads in canteens.

Like fries, most baked goods cannot endure long-term storage. Therefore, they go through processes that efficiently convert raw as well as preprocessed into produce which are fit for consumption.

Processing starchy vegetables such as potato requires colossal amounts of oil. At least 30% of this oil is absorbed into the final produce, in this case French fries. This massive absorbtion of fat can render an even a moderate consumption a serious threat to the health of the consumers.

To tackle the fat issue, this innovative device has the capability to process any desired product with a considerably low quantity of fat (5%-6%). The desired product will become crunchy and tasty as well.

Unlike the traditional ways of frying potatoes in large quantities of oil and reusing the same oil over and over, practically only a couple of tablespoons of oil is sprinkled on the potato chips before frying them in the device in question.

### DESCRIPTION OF THE DEVICE

The construction of the apparatus is based on the plan of a drive motor (4) having a square shaped shaft (5) which is located at the chamber base (19) of the cooking chamber (3). A protective plate (6) with notches (7) is supported on the chamber base (19). The heat source (1) is also supported on the chamber base (19).

For the heat source (1) there is the protective tube (8) with a face washer (9) which has hooks (10) attached to it. At the front of the protective tube (8) there is a hole (12). In the inner part of the device there is a perforated drum (15), The door of the perforated drum (16) has bolts (22) to secure the holes (24) when closed. In the perforated drum (15) we installed the heating tube (14) with blade drivers (18).

Inside the perforated drum (15), there are blade drivers (98) dividing it into four (or more as needed) equal compartments (20).

Inside the perforated drum (15) we clinch the tubular shaft (13) carrying a square hole (30). The perforated drum (15) carries a handle (84) at its rear (86) so as to be pulled out of the device. The device carries both the oil-collecting container (26) which collects the excess oil and a second container for the usage of the device as described below. The cooking chamber (3) has a door (25), a temperature switch (29), vents (27) and a glass door (28) to monitor the cooking process. The cooking chamber (3), inside the chamber floor (40) carries a lifting device (42) to lift the oil-collection container (26).

### Second Usage of the Device

There are times when we want to fry a produce with more oil. This can be done using the oil-collection container (26) which has a particular shape (FIG. 6). The oil-collection container (26) is deeper in the middle and shallower on the edges. So when oil is poured, it is collected at the bottom in small quantities (FIG. 7).

To way it works is that on the chamber floor (40) of the cooking chamber (3) there is a lifting device (42) which is pulls the lever (45) and with the help of a screw shaft (48) lifts the braces (52), the oil collection-container (26) rises, and the perforated drum (15) immerses in the oil as much as needed for the adequate sprinkling of the produce while it is rotating. By moving the lever (45) to the previous position, the oil collection container (26) goes down and in this way controls the amount of oil desired sprinkle and fry the produce.

### How to Operate the Device

To obtain-the desired result, the device operates as follows:

The figures show where and how the heat source (1) in the chamber base (19) of the cooking chamber (3) should be positioned. The chamber base (19) of the cooking chamber (3) is fixed and the protective plate (6) has notches (7).

We set the perforated drum (15) vertically, we open the drum door (16) and we put produce (e.g. potato strips (50), etc.) in approximately equal parts in the areas (20). To close the drum door (16), pegs (22) are inserted into the holes (24) which are at the perforated drum (15) and thus lock the drum door (16). We open the chamber door (25) of the cooking chamber (3) where the heat source (1) is rested. We take the protective tube (8), place it over the heat source (1) to avoid contact with the potato chips (50). The protective tube (8) bearing face washer (9), and the hooks (10), through which the partial rotation shows the arrow (11) of FIG. 4, are snapped into the notches (7) of the protective plate (6) to stabilize it.

At this stage everything is stable within the cooking chamber (3). Only the shaft (5) which has a square form, will rotate in the process of cooking. The perforated drum (15) is prepared as described earlier. We take the perforated drum (15) that having a fixed tubular shaft (13) that having a square hole (30) and we adapt it to the square shaft (5) of the drive motor (4). We fix the heating tube (14) in the perforated drum (15), to act as a <<rotating pan>>. Since it has a larger diameter than the protective tube (8), there will be no friction between these two parts during operation. The oil collection container (26) is placed under the perforated drum (15) to collect any leaking oil. After closing the chamber door (25) of the cooking chamber (3), we set the desired temperature using the switch (29) and the cooking process starts. There are ventilation holes (27) at the upper part of the cooking chamber (3). The process can be monitored through the glass door (28). As seen in FIG. 3, the advantage of this device is that the potato chips (50) (or other produce) get very close to the heat source (1).

By avoiding heat loss, there are noticeable benefits as far as the cooking speed and energy are concerned.

So the energy and time economy is great because as how far away the baking time is increased and the desired crispy potato strips (5) for is not achieved. One way to fry e.g. potato strips (50) or other type of food is not fried in frying pan in the oven, but there needs to stir often to prevent burning. With this apparatus it is like having a rotating pan, and as mentioned above, the potato strips (50) or other type of food is too close to the heat source (1) as seen in FIG. 3 by rotating shuffled themselves.

The specially designed perforated drum (15) ensures that:

By closing the door (16) the potato chips (50) or any other type of food cannot be transferred from one compartment to another. The perforated drum (15) can be partitioned into four (six, eight, ten, etc.) compartments depending on its size when it is intended for professional use.

The device can be operated with gas system as a heat source, and a motor operating on a 12V battery. This makes the device transportable as well as portable.

### BRIEF DESCRIPTION OF THE DRAWINGS

FIG. 1. This what happens inside the device and how the heat source (1) is rested, and where the axis of rotation (5) and lift system (42) are located.

FIG. 2. Display of the perforated drum (15) which is divided into four compartments (20) with blades (17), the heating tube (14) and the tubular shaft (13) with the square hole (30).

FIG. 3. Diplay of the way in which the produce (potatoes, etc.) is getting close to the heating source (1) while the perforated drum (15) is rotating. FIG. 4. Diplay of protective tube (8) with face washer (9) and the tubular hole (12).

FIG. 5. Diplay of the blade (17).

FIG. 6. Diplay of the particular form that the oil-collection container (26) has.

FIG. 7. Diplay of the way the device (42) is lifted by means of supports-braces (52), how the oil collection container (26) is lifted to sprinkle produce while the the perforated drum is rotating (15).

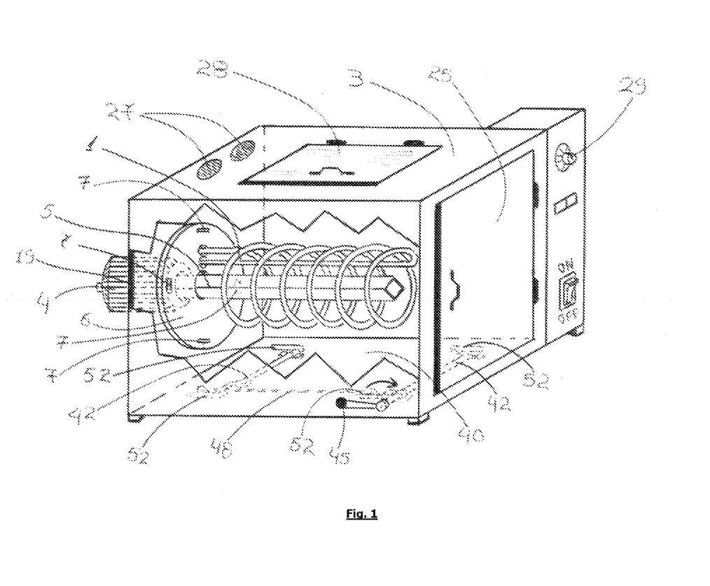

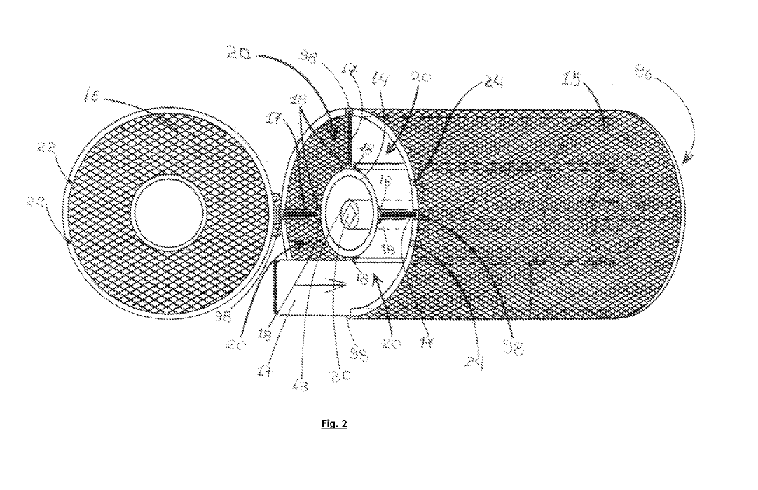

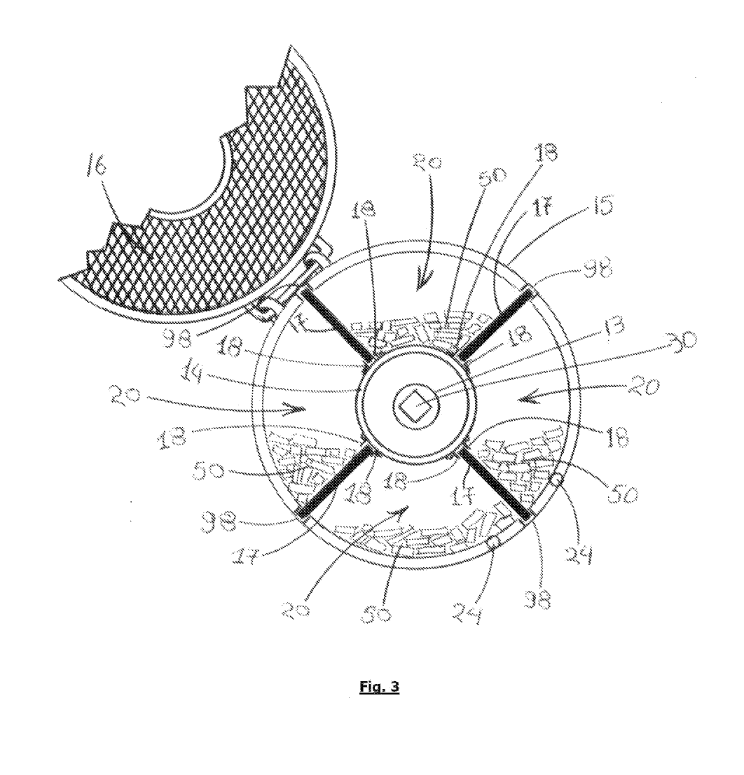

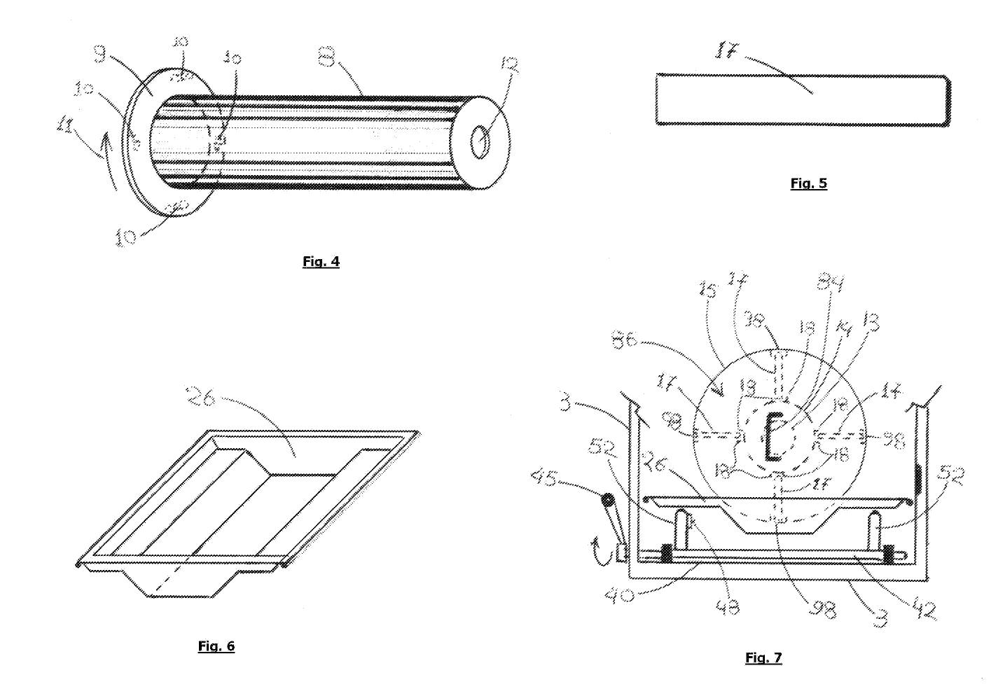

What is claimed is:

1. A cooking apparatus for food products using a heat source comprising:
a cooking chamber (3), the drive motor (4) which returns the number of the tubular shaft (13) which is fixed to the perforated drum (15). The chamber base (19) of the cooking chamber (3) have attached the heat source (1). The chamber floor (40) of the cooking chamber (3) has a lift system (42) of the oil collection container (26).

2. In the device described in claim 1, the heat source (1) is shaped to screw located in the center of the cooking chamber (3).

3. In the apparatus described in claim 1, we have fastened in the chamber base (19) of the cooking chamber (3) a protective plate (6).

4. In the device described in claim 3, the protective plate (6) has notches (7).

5. In the device described in claim 1, the drive motor (4) carries the square shaft (5) which has a square form.

6. In the device described in claim 2, the heat source (1) is protected by the protective tube (8) to avoid contact with the products.

7. In the device described in claim 6, the protective tube (8) bears face washer (9) which has hooks (10) to snap into the notches (7) of the protective plate (6).

8. In the device described in claim 1, to the chamber floor (40) of the cooking chamber (3) there is a lift system (42) having braces (52) that turning the lever (45) lift the oil collection container (26).

9. In the device described in claim 1, the perforated drum (15) is mounted in a tubular shaft (13) having a square hole (30) to enter the square shaft (5) of the drive motor (4), which serves rotation.

10. In the device described in claim 9, the perforated drum (15) is mounted on the heating tube (14), which is larger in diameter than the protective tube (8) not to have friction between them during rotation.

11. In the device described in claim 9, the perforated drum (15) has blade orders (98) on the perforated body and blade drivers (18) on the heating tube (14).

12. In the device described in claim 11, at the blade drivers (18) and blade divers (98) entering blades (17) to separate the perforated drum (15) in specific areas (20).

13. In the device described in claim 8, the oil collection container (26) has a special form to control the maximum amount of oil.
